(19) United States
(12) Patent Application Publication
(10) Pub. No.: US 2018/0123225 A1
(43) Pub. Date: May 3, 2018

(54) INTEGRATED AIRBORNE BLADE ANTENNA DESIGN

(71) Applicant: QUALCOMM Incorporated, San Diego, CA (US)

(72) Inventor: Allen Minh-Triet TRAN, San Diego, CA (US)

(21) Appl. No.: 15/272,068

(22) Filed: Sep. 21, 2016

Related U.S. Application Data
(60) Provisional application No. 62/232,932, filed on Sep. 25, 2015.

(51) Int. Cl. H01Q 1/28; H01Q 1/42; H01Q 1/38; H01Q 1/48

(52) U.S. Cl. CPC H01Q 1/282; H01Q 1/48; H01Q 1/38; H01Q 1/42

(57) ABSTRACT

Aspects of the present disclosure generally relate to antenna structures suitable for vehicles, such as aircraft.

### CLAIM OF PRIORITY UNDER 35 U.S.C. §119

The present Application for Patent claims benefit of U.S. Provisional Patent Application Ser. No. 62/232,932 (Attorney Docket number 151147USL), filed Sep. 25, 2015, which is assigned to the assignee hereof and hereby expressly incorporated by reference herein.

### BACKGROUND

Field of the Disclosure

Aspects of the present disclosure generally relate to antenna designs and, more particularly to antenna designs for aircraft, or other type of vehicle, and configuration of antenna elements housed therein.

Description of Related Art

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include Code Division Multiple Access (CDMA) systems, Time Division Multiple Access (TDMA) systems, Frequency Division Multiple Access (FDMA) systems, 3rd Generation Partnership Project (3GPP) Long Term Evolution (LTE) systems, Long Term Evolution Advanced (LTE-A) systems, and Orthogonal Frequency Division Multiple Access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-input single-output, multiple-input single-output or a multiple-input multiple-output (MIMO) system.

In Air to Ground (ATG) systems used to provide Internet access to airplanes, the airplanes are generally considered wireless terminals (or user equipments) and communicate with terrestrial Ground Base Stations (GBSs) as they fly over land. To improve communications, relatively sophisticated arrays of antennas are mounted on the airplanes. Such arrays need to be protected, for example, in some type of housing. Unfortunately, protective housings commonly referred to as “radomes” take up precious real estate on the aircraft, add weight, and air resistance.

Accordingly, improvements in how antennas are housed on aircraft are desirable.

SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure provide an antenna structure for use on a surface of an aircraft. The antenna structure generally includes a radome, a plurality of antenna radiating elements integrated in and enclosed by the radome, and at least one printed circuit board (PCB) with integrated circuits (ICs) to drive the antenna radiating elements.

Certain aspects of the present disclosure provide an apparatus for wireless communications on a vehicle. The apparatus generally includes an antenna structure for mounting on a surface of the vehicle, at least one processor to generate packets for transmission via the antenna structure, wherein the antenna structure generally includes a radome, a plurality of antenna radiating elements integrated in and enclosed by the radome, and at least one printed circuit board (PCB) with integrated circuits (ICs) to drive the antenna radiating elements.

Certain aspects of the present disclosure provide an apparatus for wireless communications on an aircraft. The apparatus generally includes an antenna structure and at least one processor configured to generate packets for transmission to a ground base station via the antenna structure. The antenna structure generally includes a radome, a plurality of antenna radiating elements integrated in and enclosed by the radome, and at least one printed circuit board (PCB) with integrated circuits (ICs) to drive the antenna radiating elements.

Certain aspects of the present disclosure provide a radome suitable for mounting on a surface of a vehicle. The radome generally includes an outer surface formed of a protective material and a plurality of antenna radiating elements integrated in the radome and enclosed by the outer surface of the radome.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram illustrating an Air to Ground (ATG) system, in accordance with certain aspects of the present disclosure.

FIG. 2 illustrates a block diagram of a base station and a user equipment, in accordance with certain aspects of the present disclosure.

FIG. 3 illustrates an example ground station serving multiple aircraft which may have antenna structures, in accordance with certain aspects of the present disclosure.

FIGS. 4A, 4B, and 4C illustrate an example antenna structure, a top view of the example antenna structure, and a back view of the example antenna structure, in accordance with aspects of the present disclosure.

FIGS. 5A and 5B illustrates an example back view of the antenna structure of FIG. 4, in accordance with aspects of the present disclosure.

### DETAILED DESCRIPTION

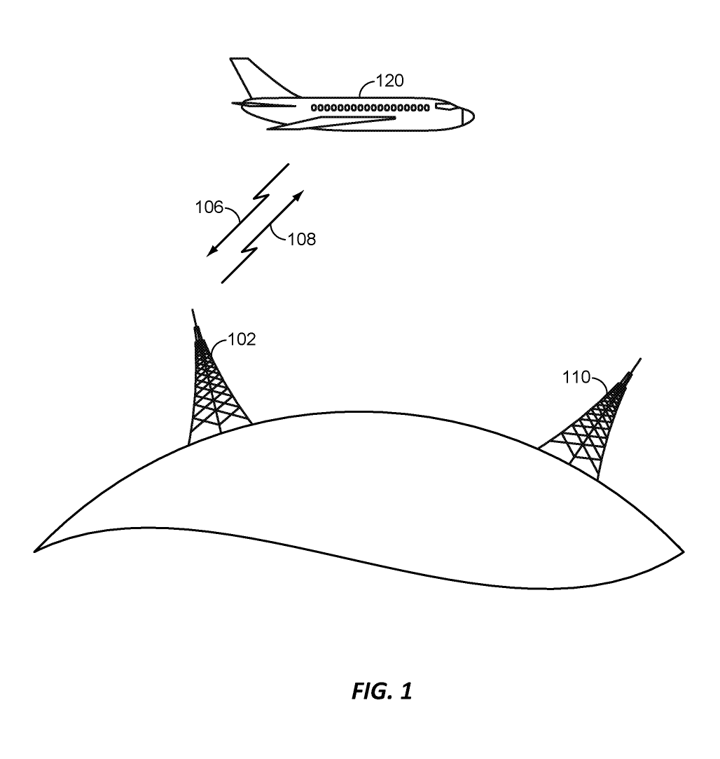

Aspects of the present disclosure provide antenna structures that may help improve performance of wireless communications between ground base-stations and aircraft in an air-to-ground (ATG) system, such as that shown in FIG. 1. The antenna structures may allow for sufficient protection of antenna arrays and associated components in a compact package with relatively low air resistance.

According to certain aspects, rather than just providing a protective covering, as with conventional radomes, a radome is provided with antenna radiating elements integrated therein. As will be described in greater detail below, integrating the antenna radiating elements into the radome structure may eliminate the need for a separate radome enclosure. In some cases, the antenna radiating elements may be formed as apertures in a metal blade-shaped radome and, in some cases, may be filled with a dielectric material.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” 3GPP2).

Single carrier frequency division multiple access (SC-FDMA) is a transmission technique that utilizes single carrier modulation at a transmitter side and frequency domain equalization at a receiver side. The SC-FDMA technique has similar performance and essentially the same overall complexity as those of an OFDMA system. However, an SC-FDMA signal has a lower peak-to-average power ratio (PAPR) because of its inherent single carrier structure. The SC-FDMA technique has drawn great attention, especially in the uplink communications where lower PAPR greatly benefits the mobile terminal in terms of transmit power efficiency. Use of SC-FDMA is currently a working assumption for uplink multiple access scheme in the 3GPP LTE and the Evolved UTRA.

An access point (“AP”) may comprise, be implemented as, or known as a NodeB, a Radio Network Controller (“RNC”), an eNodeB, a Base Station Controller (“BSC”), a Base Transceiver Station (“BTS”), a Base Station (“BS”), a Ground Base Station (“GBS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as an access terminal, a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), an aircraft, an aircraft transceiver located on an aircraft, or some other suitable processing device connected to a wireless modem.

### Example Wireless Communications System

FIG. 1 illustrates an example air-to-ground (ATG) system in which aspects of the present disclosure may be utilized. In one aspect, the ATG system includes one or more ground base station 110 that transmits and receives signals on a satellite uplink band using a forward link (FL) 108 and a reverse link (RL) 106. An aircraft transceiver (AT) 120, which may be considered a user equipment (UE), in communication with the ground base station 102 may also transmit and receive signals on the satellite uplink band using the forward link 108 and reverse link 106. In one aspect, the aircraft transceiver 120 may include a multi-beam switchable array antenna. Another ground base station 110 is also shown.

In one aspect, the aircraft transceiver 120 may utilize an aircraft antenna that is comprised of a multi-beam switchable array that is able to communicate with the ground base station 102 at any azimuth/elevation angle. The aircraft antenna may be mounted in any suitable location, for example, below the fuselage with a small protrusion and aerodynamic profile to reduce or minimize wind drag. In one aspect, the antenna elevation coverage is from approximately 3 degrees to 10 degrees below horizon.

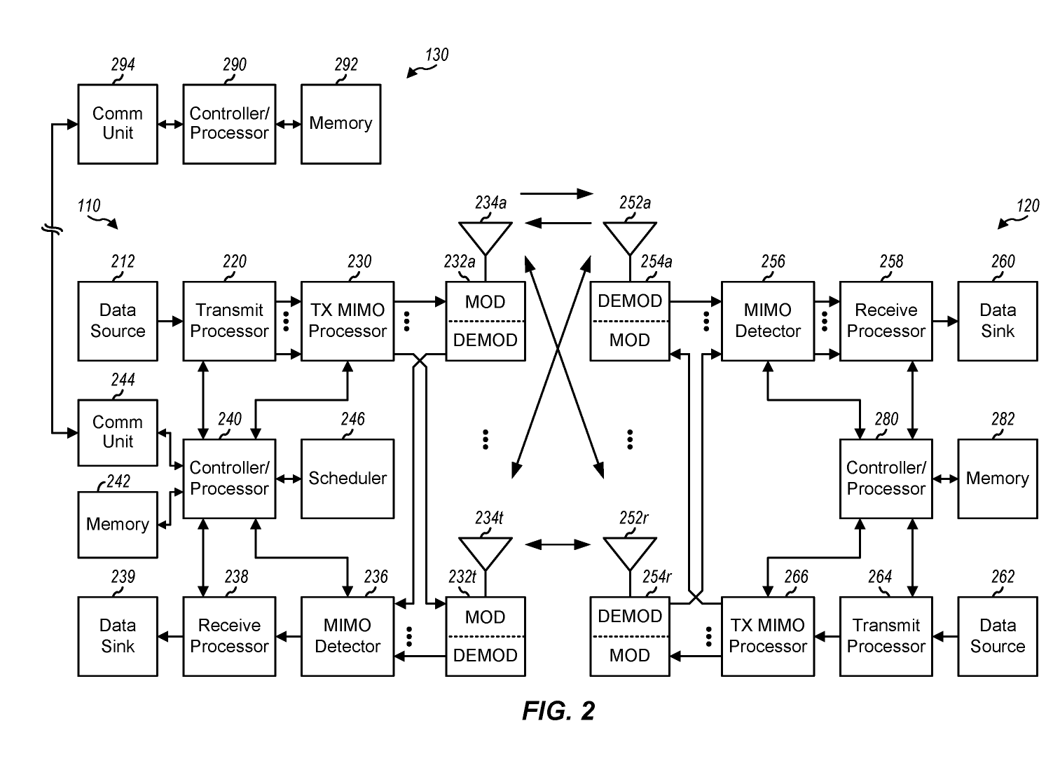

FIG. 2 illustrates example components of the ground base station/eNB 110 and AT/UE 120 illustrated in FIG. 1, in which LTE-based communications may be used to implement an ATG system.

FIG. 2 illustrates a block diagram of one example of base station 110 (which may be a ground base station) and a user equipment 120 (which may be an aircraft transceiver with an antenna elements 252 arranged in an efficient antenna design as presented herein) in a multiple-input multiple-output (MIMO) system.

At BS 110, a transmit processor 220 may receive data from a data source 212 for one or more UEs, select one or more modulation and coding schemes (MCSs) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI), etc.) and control information (e.g., CQI requests, grants, upper layer signaling, etc.) and provide overhead symbols and control symbols. Processor 220 may also generate reference symbols for reference signals (e.g., the common reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each MOD 232 may process a respective output symbol stream (e.g., for OFDM, etc.) to obtain an output sample stream. Each MOD 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from BS 110 and/or other BSs and may provide received signals to demodulators (DEMODs) 254a through 254r, respectively. Each DEMOD 254 may condition (e.g., filter, amplify, downconvert, and digitize) its received signal to obtain input samples. Each DEMOD 254 may further process the input samples (e.g., for OFDM, etc.) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The controller/processor may store information regarding the operation of a crystal oscillator (e.g., a crystal oscillator in a demodulator) at the temperature in memory 282. While receiving a signal, the controller/processor and/or receive processor may use information regarding the operation of the crystal oscillator and the temperature in determining a precision of the crystal oscillator. A channel processor may determine reference signal received power (RSRP), received signal strength indicator (RSSI), reference signal received quality (RSRQ), CQI, etc.

On the uplink, at UE 120, a transmit processor 264 may receive and process data from a data source 262 and control information (e.g., for reports comprising RSRP, RSSI, RSRQ, CQI, etc.) from controller/processor 280. Processor 264 may also generate reference symbols for one or more reference signals. The symbols from transmit processor 264 may be precoded by a TX MIMO processor 266 if applicable, further processed by MODs 254a through 254r (e.g., for SC-FDM, OFDM, etc.), and transmitted to BS 110. At BS 110, the uplink signals from UE 120 and other UEs may be received by antennas 234, processed by DEMODs 232, detected by a MIMO detector 236 if applicable, and further processed by a receive processor 238 to obtain decoded data and control information sent by UE 120. Processor 238 may provide the decoded data to a data sink 239 and the decoded control information to controller/processor 240. BS 110 may include communication unit 244 and communicate to network controller 130 via communication unit 244. Network controller 130 may include communication unit 294, controller/processor 290, and memory 292.

Controllers/processors 240 and 280 may direct the operation at BS 110 and UE 120, respectively. Memories 242 and 282 may store data and program codes for BS 110 and UE 120, respectively. A scheduler 246 may schedule UEs for data transmission on the downlink and/or uplink.

### Example Antenna Design

As described above, in ATG systems, aircraft (which may be considered UEs) may communicate with a ground base station using one or more radio access technologies (RATs). For example, LTE communications may be used for the uplink receiver of such a system (to process uplink signals received from aircraft). Such a system may operate, for example, at 14.0-14.5 GHz Ku band and co-exist with primary satellite communications.

Aspects of the present disclosure provide antenna designs suitable for mounting on aircraft. As will be described in greater detail below, such designs may include one or more antenna arrays and may improve performance of such an ATG system (e.g., relative to systems utilizing conventional antenna designs with separate radomes) with relatively minor impact on weight and air resistance.

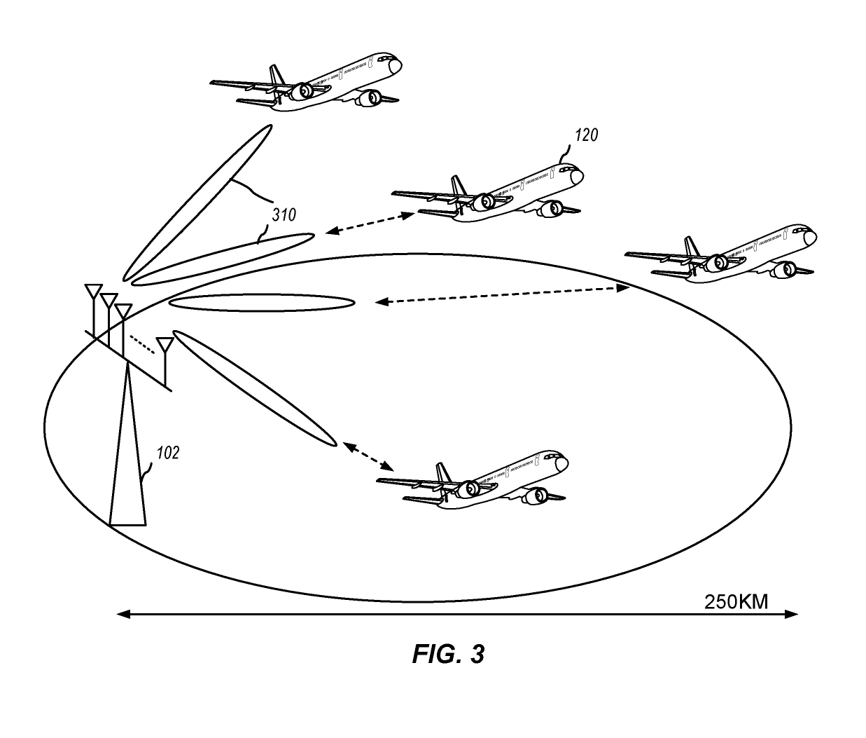

An example of such an ATG system in which aspects of the present disclosure may be utilized is illustrated in FIG. 3. In such systems, for the ATG communication, UEs 120 (the aircrafts) may not be allowed to radiate too much power since that might impact the primary use of satellite communications. Moreover, such systems may be designed to support a multi-gigabit per second (Gbps) data rate with the 250 MHz bandwidth. As illustrated, a ground base station 102 may be controlled to steer beams 310 in an effort to optimize communications to any particular aircraft.

Antenna designs presented herein may help enable a high-gain antenna installation for an aircraft transceiver 120 in compact form-factor with low drag coefficient that is desirable for commercial aircrafts. Conventionally, high-gain aircraft antennas (using separate radomes) are large and often require major change to aircraft body structure for installation. The antenna structures described herein may help allow for a much more compact design that is more suitable for airborne applications.

Certain antenna designs presented herein may help achieve these design goals by incorporating antenna elements into a radome rather than using a separate radome. Rather than simply provide protection by covering antenna elements, aspects of the present disclosure provide radomes with radiating antenna elements incorporated therein. Such designs may help avoid problems associated with the use of separate radomes, such as unwanted feedback, reflections, reduced gain, and increased air resistance. The integrated design described herein may help minimize size and optimize arrays for improved performance (e.g., using beamforming).

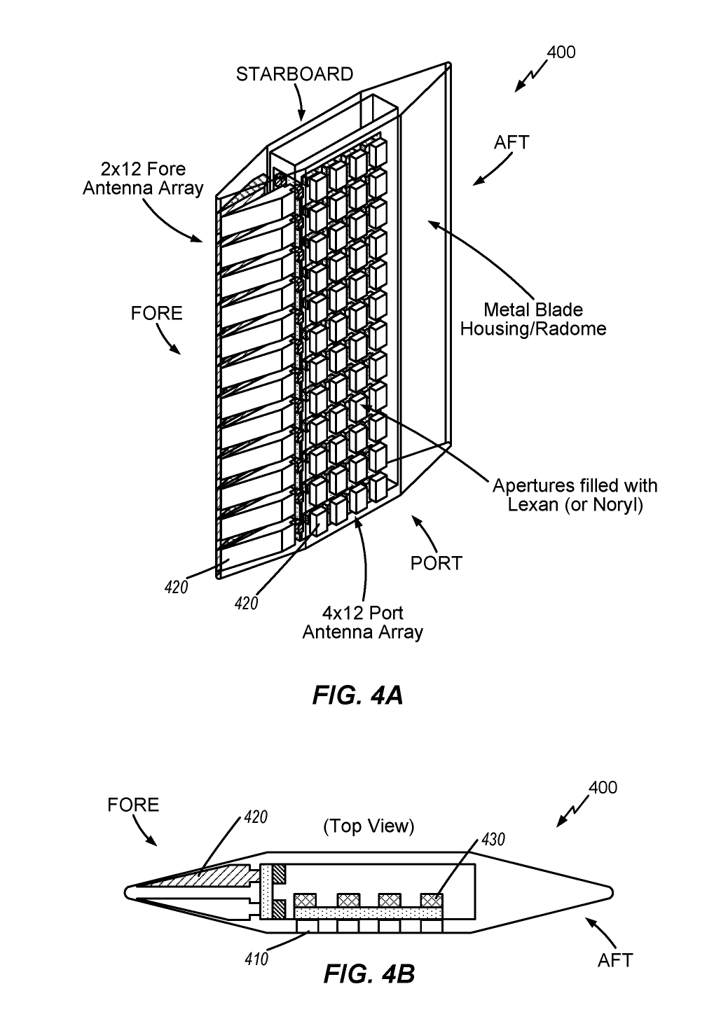

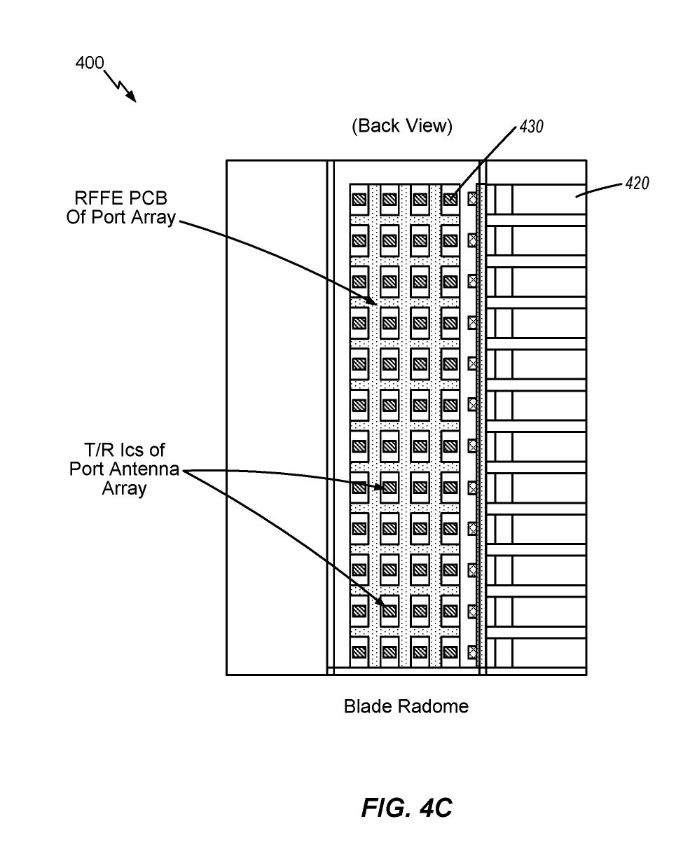

As illustrated in FIG. 4A, certain aspects of the present disclosure provide a relatively narrow “blade” design 400 with the radome integrated with the antenna apertures as an integral part of the antenna design. In this manner, the overall dimensions of the antenna structure may be reduced, while still providing antenna arrays with sufficient antenna gain and directional flexibility. As used herein, the term aperture generally refers to an area, oriented perpendicular to the direction of an incoming radio wave, which would intercept the same amount of power from that wave as is produced by an antenna receiving the wave.

According to certain aspects, antenna elements (410 and 420) may be arranged in different types of arrays, which may be designed to achieve certain performance characteristics. For example, as illustrated in FIG. 4A, the antenna elements of the antenna arrays 420 covering the Fore direction (towards a front of the aircraft) and Aft direction (towards the rear of the aircraft) may be uniquely designed and oriented to take advantage of the slim taper of the blade (tapered) in c directions for higher gain performance than a typical antenna element (e.g., such as patch or slot antenna elements). On the other hand, antenna elements 410 covering the port and starboard directions may take advantage of additional area on those sides.

Any suitable shapes, dimensions, and materials may be used to construct the radome. For example, the radome may be constructed as a thin metal blade design less than an inch thick, with a suitable length and depth to accommodate the antenna arrays. In some cases, the dimensions may be selected such that an aspect ratio between a length of the apparatus and a thickness of the apparatus is a certain value (e.g., greater than or equal to five). In one example embodiment, a design as shown in FIG. 4A may be 0.86″ T×5″ W×7″ L.

As noted above, integrating the antenna elements into the radome structure, may eliminate the need for a separate radome enclosure, but may still be designed to provide some level of protection. For example, in some cases, the radome may have a thin coating of material for environmental protection. In some cases, antenna radiating elements may be formed as apertures in the metal blade and, in some cases, these apertures may be filled with a dielectric material. Any suitable dielectric material may be used for this purpose (such as Lexan or Noryl).

The structure may be formed using any suitable techniques. For example, in some cases, the structure may be formed with casting (of the metal portion) or two piece machining, first forming a metal structure then forming the apertures in place (e.g., molded with any electrically suitable material). It should be noted that a metal radome may also help with heat dissipation (as the ICs may generate significant heat).

As illustrated in the Side View of FIG. 4A, top view of 4B, and back view of FIG. 4C, transceiver ICs 430 (e.g., beamforming ICs) may be used to drive all columns (of antenna elements 410/420). In some cases, beamforming transceiver ICs may utilize phase shifting to drive antenna elements in each array. Further, the particular arrays may be designed to achieve a desired antenna gain (e.g., at least 15 dB in some cases).

As illustrated, different size arrays of antenna elements may be used for different directions of the structure shown in FIG. 4A. For example, an array of 2×12 antenna elements 410 may be utilized in first and second (e.g., Fore and/or Aft) sides, while 4×12 (or 2×12) antenna elements 420 may be used for third and fourth (e.g., Port and Starboard) sides of the structure.

As noted above, each antenna aperture may be fed by a T/R IC 430 mounted on a PCB panel installed behind the antenna apertures. In some cases, the PCB may have transmission lines (e.g., 50-ohm striplines) to carry signals from the T/R IC.

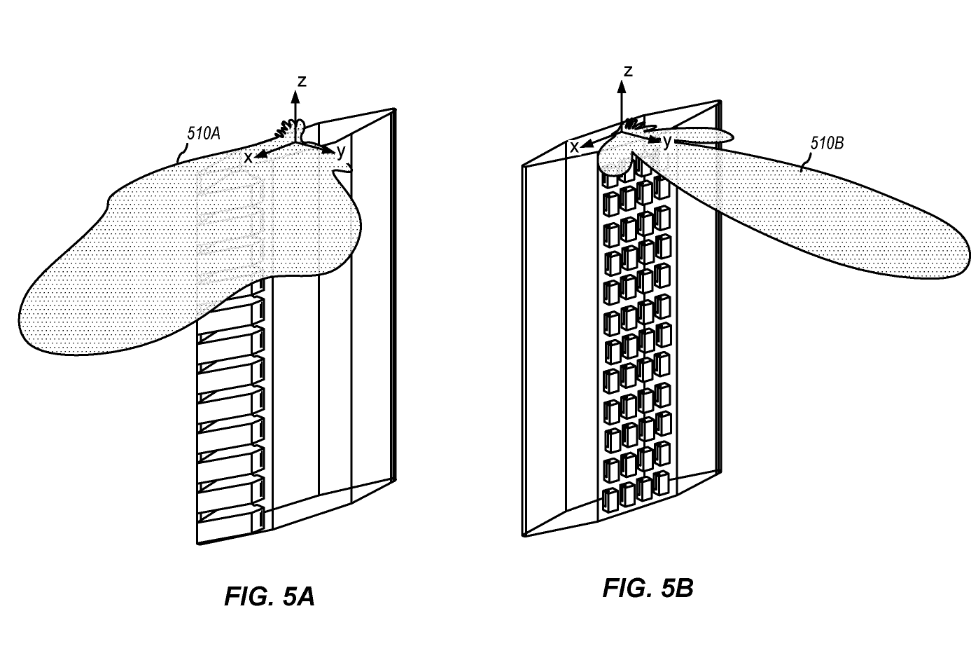

As illustrated in FIGS. 5A and 5B, each of the antenna array beams can be steered in both Azimuth and Elevation to maximize gain performance. For example, FIG. 5A illustrates how an antenna array may be used to steer a beam 510A in the fore direction. Similarly, FIG. 5B illustrates how an antenna array may be used to steer a beam 510B in the port direction. Beam shaping can also be done with proper weighting applied to each corresponding array.

Simulation results have shown that designs described herein may achieve adequate antenna gain performance for various azimuth and elevation patterns. Such simulations may take into account metal and dielectric losses. For example, assuming aluminum is used to form the radome structure and the antenna openings are filled with Lexan, a loss tangent may be included at a certain frequency (e.g., at 10 GHz.

As another example, simulations may assume a material referred to as Taconic RF-35 is used for the stripline feed of the antenna and the simulations may include a corresponding loss tangent.

Simulations may also demonstrate the effect of the body of the aircraft (e.g., acting as ground) and effects of certain body elements (such as the fuselage) may be simulated. The body may be simulated, for example, by considering an infinitely large ground plane mounted above the blade or a ground plane of a given size (e.g., a 30″ long by 20″ or 40″ long by 20″ wide finite ground plane at 1″ above the blade.

As noted above, the antenna structures described herein may be suitable for use in various scenarios. For example, the relatively thin blade structure described herein may be suitable for commercial installation (e.g., in aircraft or various other types of moving craft).

In addition, direct integration of the antenna elements within the (e.g., metal) radome, as described herein, may help reduce or eliminate the typical sensitive airgap distance between the antenna aperture and the conventional dielectric radome. Further, integrating antenna elements in the radome may help negate the typical coupling interaction between the standalone antenna aperture and separate radome enclosure, as well as typical diffraction and insertion loss issues relative to the conventional, stand-alone radome structure. These benefits may be achieved in an efficiently packaged structure which may satisfy the stringent deployment objectives of the airline industry.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor.

According to certain aspects, such means may be implemented by processing systems configured to perform the corresponding functions by implementing various algorithms (e.g., in hardware or by executing software instructions) described above. For example, an algorithm for receiving, from a BS, configuration information for RAN aggregation for one or more data bearers and offloading rules for WLAN offloading, an algorithm for determining a priority for communicating using RAN aggregation and offloading rules based, at least in part, on the received configuration information, and an algorithm for performing RAN aggregation or WLAN offloading according to the offloading rules based on the determined priority.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An antenna structure for use on a surface of an aircraft, comprising:
a radome;
a plurality of antenna radiating elements integrated in and enclosed by the radome; and
at least one printed circuit board (PCB) with integrated circuits (ICs) to drive the antenna radiating elements.

2. The antenna structure of claim 1, wherein the antenna radiating elements comprise apertures formed in the radome.

3. The antenna structure of claim 2, wherein:
the radome is formed of metal; and
the apertures are filled with a dielectric material.

4. The antenna structure of claim 1, wherein an aspect ratio between a length of the radome and a thickness of the radome is greater than or equal to five.

5. The antenna structure of claim 1, wherein the PCB has a transmission line to carry a signal from the ICs to the antenna radiating elements.

6. The antenna structure of claim 1, wherein the plurality of antenna radiating elements comprise:
a first array of antenna radiating elements integrated in the radome and oriented to radiate in a first direction; and
at least a second array of antenna radiating elements oriented to radiate in a second direction.

7. The antenna structure of claim 6, wherein the plurality of antenna radiating elements comprise:
a third array of antenna radiating elements integrated in the radome and oriented to radiate in a third direction; and
at least a fourth array of antenna radiating elements oriented to radiate in a fourth direction.

8. The antenna structure of claim 7, wherein:
the first direction is towards a fore of the aircraft; and
the second direction is towards an aft of the aircraft.

9. The antenna structure of claim 8, wherein:
the third direction is towards a port side of the aircraft; and
the fourth direction is towards a starboard side of the aircraft.

10. The antenna structure of claim 8, wherein:
the radome is tapered in at least one of the first or second direction.

11. The antenna structure of claim 10, wherein at least one of the first or second arrays has a different number of antenna radiating elements than at least one of the third or fourth arrays.

12. The antenna structure of claim 10, wherein antenna radiating elements of at least one of the first and second arrays has a different size or dimensions than antenna radiating elements of the third or fourth arrays.

13. The antenna structure of claim 8, further comprising:
at least one processor configured to steer an antenna array beam from at least one of the first, second, third, or fourth arrays, in both azimuth and elevation.

14. The antenna structure of claim 13, wherein the at least one processor is also configured to perform beam shaping of the antenna array beam.

15-20. (canceled)
